(19) United States
(12) Patent Application Publication
(10) Pub. No.: US 2007/0233561 A1
(43) Pub. Date: Oct. 4, 2007

(54) Automated Lead Scoring

(76) Inventor: Christopher Golec, Sausalito, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/457,664

(22) Filed: Jul. 14, 2006

Related U.S. Application Data
(60) Provisional application No. 60/743,855, filed on Mar. 28, 2006.

(51) Int. Cl. G06Q 30/00

(52) U.S. Cl. 705/14

(57) ABSTRACT

Effective acquisition of high-quality sales leads is provided. Businesses provide scoring criteria, representing the relative importance of a potential customer's attributes, such as sales revenue, number of employees, industry, geographic location, etc. A scoring engine determines a score for the combination of a potential customer and one or more businesses by applying the criteria in the business' quality profile to the attribute values provided by the potential customer. If the score exceeds a threshold, information about the potential customer is provided to the business at a customized price. The business can then purchase contact information for the potential customer. If the business does not pursue the potential customer, the lead may be offered to additional businesses in a secondary marketplace. A business that agrees to have rejected leads contributed to the secondary marketplace can be issued a credit against past or future leads purchases.

### CROSS-REFERENCE TO RELATED APPLICATIONS

This application claims the benefit of U.S. Provisional Application 60/743,855, filed on Mar. 28, 2006, and incorporated by reference herein in its entirety.

This application is related to U.S. patent application Ser. No. 11/_______, filed on Jul. 13, 2006 and titled “Secondary Marketplace For Leads”; and to U.S. patent application Ser. No. 11/______, filed on Jul. 13, 2006 and titled “Acquiring Leads Using Scoring”. Both applications are incorporated by reference herein in their entirety.

### BACKGROUND OF THE INVENTION

1. Field of the Invention

The present invention relates generally to acquisition and management of sales leads. In particular, the present invention is directed to acquiring sales leads and efficiently ranking and delivering them to businesses for which they are the most desirable.

2. Description of Background Art

To acquire new customers, businesses spend marketing dollars to create selling opportunities for their sales teams or channels to act on. A precursor to a bona fide selling opportunity is a sales lead—a person or company, sometimes called a prospect, that may or may not be interested in the products and services offered. It is the acquisition of sales leads that is a notoriously difficult process, owing to the subjective way in which leads are valued by businesses and the difficulty of converting potential leads to selling opportunities.

Businesses invest in a variety of marketing programs or campaigns to generate sales leads. Sales leads vary greatly in quality across programs, campaigns and lead sources. Higher quality leads—those that are believed to have a higher probability of ultimately generating revenue—generally cost more on a per lead basis. For example, sales leads originating from the Internet typically cost the least per lead, but produce the lowest quality leads on average. Conversely, sales leads originating from other marketing programs such as telemarketing and inside sales, produce higher quality leads on average and generally cost more on a per lead basis.

In an attempt to minimize the average cost per lead and create the highest volume of sales leads for a given marketing budget, it is not uncommon for marketing departments to generate a high proportion of lower quality or “bad” leads, frequently 25% or greater. A “bad” lead is one that is incomplete, inaccurate, or generally does not fit the profile of a target customer well enough to be useful to a sales person. For example, the prospect may be employed by a company operating in a non-target industry, that has an unsatisfactory credit risk, or is simply too small in terms of annual revenue.

Leads from the Internet, either from a web site or search marketing programs provide a useful example. Most companies that invest in some type of online marketing find that less than 10% of web inquiries become useful sales leads. While companies may only pay $1-$2 per click in an online advertising campaign for a web visit, the real cost of a quality lead from this type of program can become hundreds or even thousands of dollars depending on the quality definition. While the click or visit to a web page may cost only $1-$2, only a few percent of those web visitors will actually provide their information or enter a request for a follow up action by the business. If 2% of web visitors provide their contact information, then the cost becomes $100 per lead ($2 divided by 2%). Of those that request information to generate an inquiry, less than 10% are likely to be from a target buyer of the product or service. This yields a cost per lead of $1,000 ($100 divided by 10%). This single program leaves discretion for marketing representatives to report a cost per lead of $2, $100, or $1,000 and a lead volume ranging from thousands to dozens.

Accordingly, what is needed is a system and method for acquiring sales leads that allows businesses to easily distinguish quality level, normalize marketing programs, and prevent money from being spent on a high proportion of “bad” sales leads.

### SUMMARY OF THE INVENTION

The present invention enables acquisition of high quality sales leads in an effective manner. Businesses provide quality profiles to a system of the present invention. Quality profiles represent the relative importance to the business of a potential customer's attributes, such as sales revenue, number of employees, industry, geographic location, and the like. When a potential customer becomes known to the system, a scoring engine determines a score for the combination of the potential customer and one or more businesses. The score is determined by applying the criteria in the business' quality profile to the attribute values provided by the potential customer. If the score exceeds a threshold score established by the business, information about the potential customer is provided to the business. If the business is interested in the potential customer, it can obtain further information including contact information for the potential customer, for example by payment of a fee. In one embodiment, if the business is not interested in pursuing the potential customer, information about the potential customer is then offered to one or more additional businesses in a secondary marketplace. In one embodiment, a business that agrees to have its rejected leads contributed to the secondary marketplace is issued a credit against past or future purchases from the system.

### BRIEF DESCRIPTION OF THE DRAWINGS

FIG. 1 illustrates a system for providing sales leads in accordance with an embodiment of the present invention.

FIG. 2 illustrates a user interface screen for collecting data from a lead in accordance with an embodiment of the present invention.

FIG. 3 illustrates a lead record in accordance with an embodiment of the present invention.

FIG. 4 illustrates a quality profile record in accordance with an embodiment of the present invention.

FIG. 5 illustrates a user interface for configuring a quality profile in accordance with an embodiment of the present invention.

FIG. 6 is a flow chart illustrating a method for scoring leads in accordance with an embodiment of the present invention.

FIG. 7 is a table illustrating the association of lead scores and businesses in accordance with an embodiment of the present invention.

FIG. 8 is a flow chart illustrating a method for providing leads to business in accordance with an embodiment of the present invention.

FIG. 9 illustrates a user interface for purchasing leads in accordance with an embodiment of the present invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

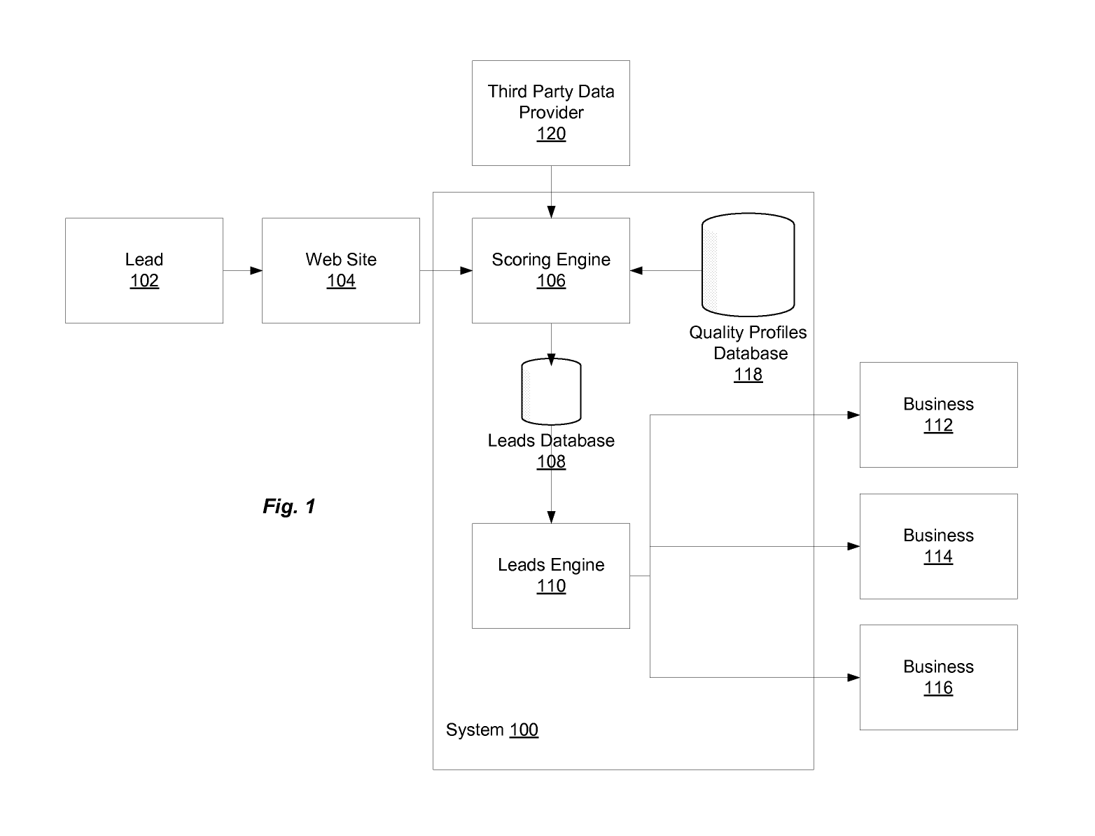

FIG. 1 illustrates a system 100 for providing leads in accordance with an embodiment of the present invention. Information about a lead 102 is provided to a web site 104. For purposes of this disclosure, and in keeping with conventional use of the term in the art, a lead refers broadly to a prospective or potential customer of the business, and a person acting on behalf of that potential customer—for example, the potential customer may itself be a business, a consumer, or an executive of the potential customer. Accordingly, the information provided about the lead 102 to the web site 104 typically comes from the lead 102 itself.

Web site 104 includes a web server configured to serve pages to clients over a wide area network such as the Internet. Web site 104 is operated by or on behalf of a business 112 with which the lead 102 desires to interact. Content served by web site 104 includes an information gathering interface, which allows lead 102 to provide information about itself to the business 112, such as information about its size, financial ability, etc., as described further below. Note that a “size” of a lead can refer not only to a business' revenue, but alternatively to its number of employees, number of locations, number of products offered for sale, or other metrics.

Web site 104 provides the information collected from lead 102 to a scoring engine 106. Scoring engine 106 scores the lead 102 based on the information received about the lead 102 from the web site 104, and weighted according to a quality profile provided by business 112, and stored in a quality profiles database 118. A record of the lead 102 and its associated scores for each business is then stored in a leads database 108. A leads engine 110 provides leads 102 in leads database 108 to the business according to each lead's score with respect to each business. As described below, this process optimizes the available leads such that each business gets leads that are of subjectively high quality to that business.

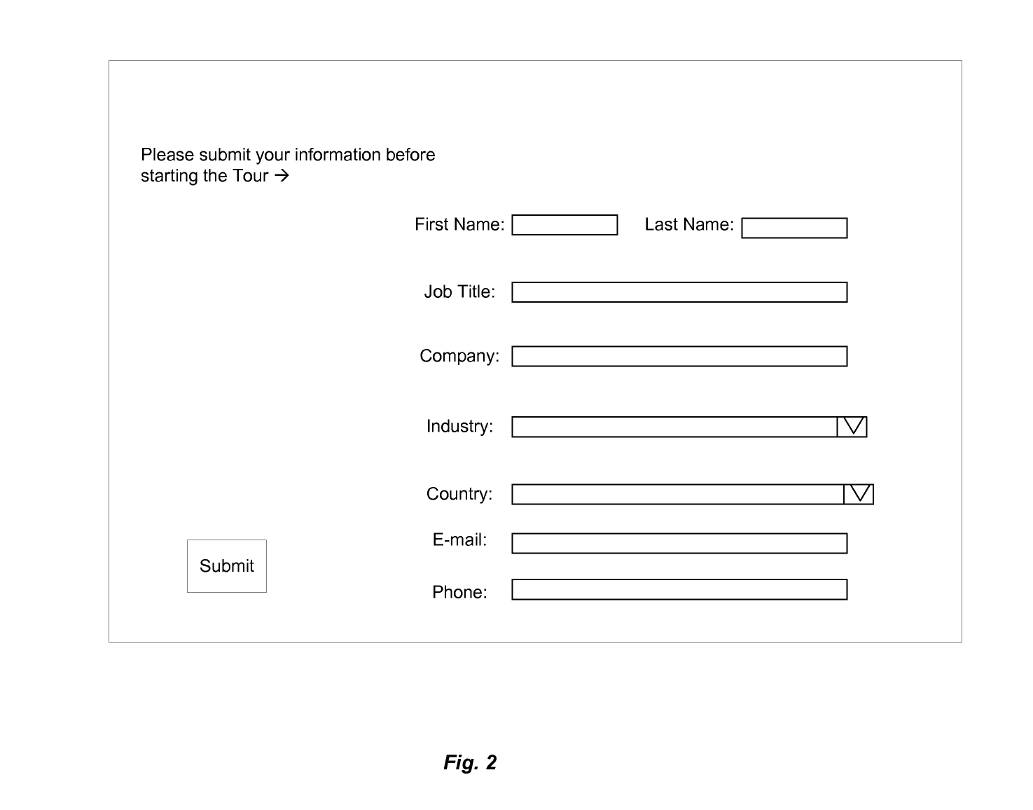

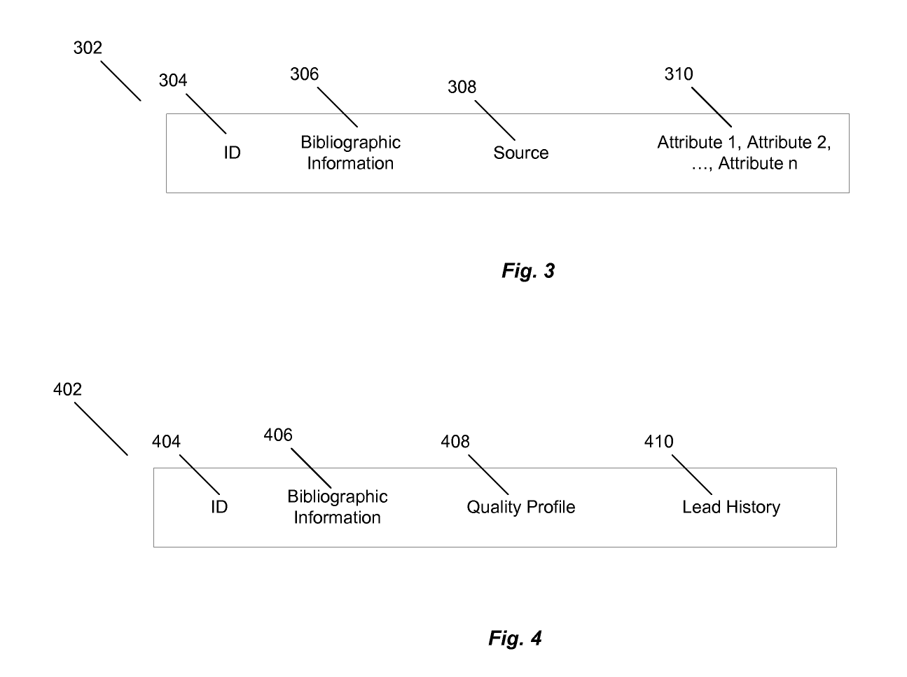

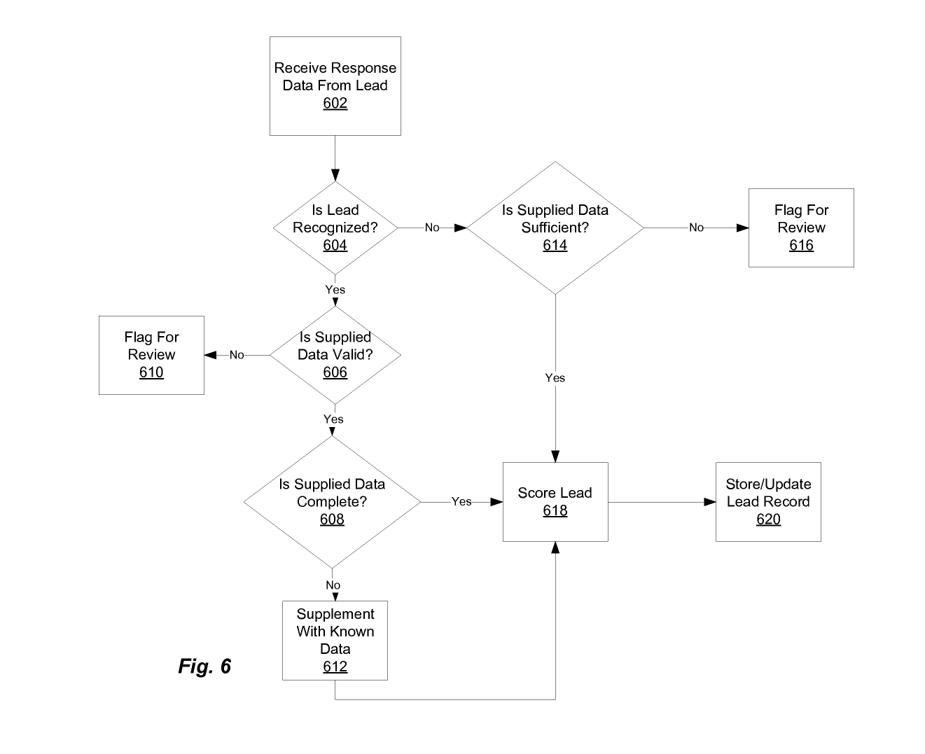

System 100 can be made aware of leads in many ways. For example, a lead prospect may be using an Internet search engine to search for businesses, and may come upon a business' web site through one of the search results. Alternatively, the lead 102 may have been referred by an existing customer, an advertisement, a third party or in some other manner. When the lead 102 visits the web site 104 of a particular business 112 and indicates an interest in contacting or being contacted by the business for a potential business relationship, web site 104 gathers information from the lead 102 concerning various biographic and demographic information. An example of a web page user interface (UI) for collecting data from a lead is illustrated in FIG. 2. The collected data provided by the web site 104 may be supplemented with third party data from a third party data provider 120, for example as described below with respect to FIG. 6, and is then delivered to scoring engine 106 of system 100. In one embodiment data provided by the lead is first normalized before being scored by scoring engine 106. For example, where the name of a contact for the lead includes a person's operating title (“CEO”, “software engineer”, “sales”, etc.), a rule-based mapping can be used to transform the provided operating title into a normalized “department” and “sub-department” that matches data in a business' quality profile. This kind of mapping is useful, for example, for allowing non-quantitative or free-text responses that a lead might provide to be appropriately scored. In one embodiment, the data is provided in the form of a lead record, such as illustrated in FIG. 3. In the illustrated embodiment, a lead record 302 includes a lead ID 304; bibliographic information 306; a lead source 308; and one or more lead attributes 310. Lead ID 304 is preferably an identifier that uniquely identifies the lead. Bibliographic information 306 includes data about the lead such as, for example, a business name, contact person, address, telephone number, and the like. Lead source 308 indicates which web site 104 is the source of the lead. Finally, lead attributes 310 include data provided by the lead, and third party data sources, that will be used to score the lead as described below. For example, lead attributes in one embodiment include industry, geography, annual sales, and number of employees. Lead attributes are described further below.

Because what is a valuable lead for one business might be a bad lead for another, system 100 allows each business to specify weights to be applied to different attributes of a lead, in determining a lead's score. Weights may be assigned using numerical values or through qualitative methods based on survey response, for example by indicating that a particular attribute is “very important”, or “not important”, etc. The attributes described here are intended to be illustrative but not limiting—in implementation, any set of attributes could be used as deemed appropriate.

In one embodiment, attributes are classified as standard or custom attributes. Standard attributes are those that are common across most businesses. Custom attributes are those that a business creates to accommodate its own selling and marketing requirements. Both standard and custom attributes can be further classified into one of three types: demographic, scale, and velocity. Demographic attributes describe characteristics of a potential customer including, for example, market, revenue, department, and level in organization.

Scale type attributes are those that impact the size of a potential relationship between the customer and the business. For example, scale attributes may include the customer's number of employees, square footage available, number of computer workstations, and the like.

Velocity attributes are those that impact how quickly a potential customer is seeking to do business. For example, attributes may include whether the customer's budget has received approval, whether necessary permits and certifications have been obtained, and whether the contact was buyer initiated.

A business influences the score assigned by scoring engine 106 to a lead 102 by establishing a quality profile, which in one embodiment is stored in quality profiles database 118. The lead quality profile for the business specifies what weights are to be assigned by scoring engine 106 to the responses received from the lead 102 and any supplemental data sources.

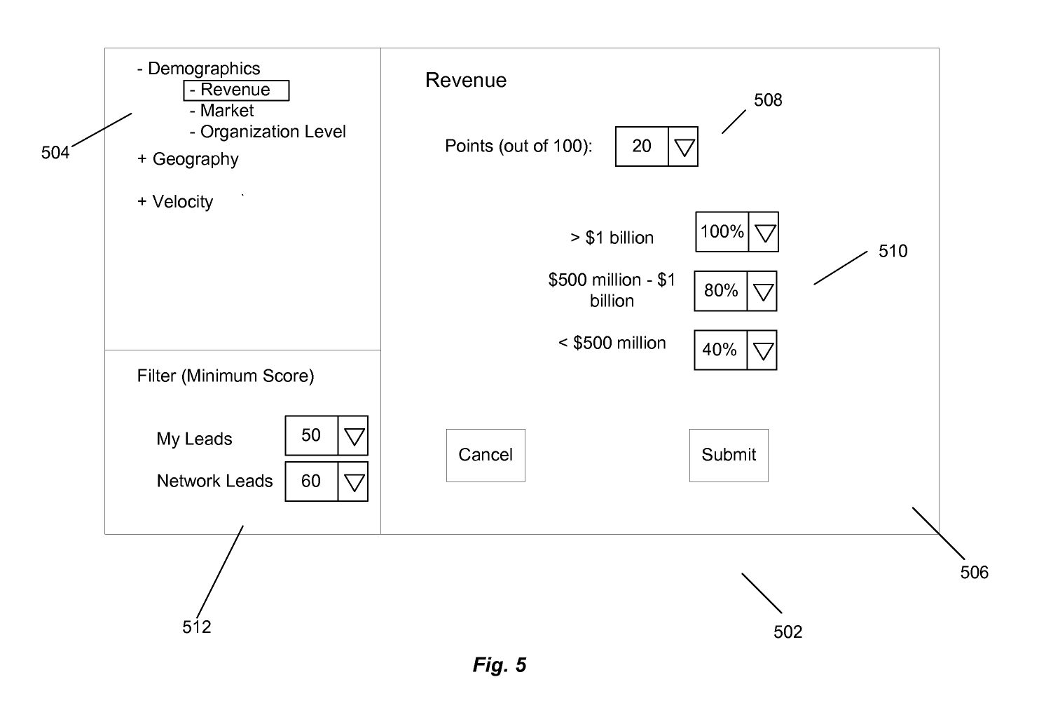

A user interface 502 (UI) for configuring a quality profile is illustrated in FIG. 5. As will be appreciated by those of skill in the art, the particular arrangement of the user interface 502 illustrated in FIG. 5 is meant to serve only as an example, and in practice the form of the user interface may vary from implementation to implementation. In addition, although a business is described here as having only a single quality profile, in practice a business can have multiple quality profiles—for example, each associated with a different product line or advertising campaign.

In one region 504 of the UI, a list of the attributes to be evaluated for a lead is presented. Selecting an attribute from the list displays configuration options for that attribute in another region 506 of the UI 502. In the example illustrated in FIG. 5, the attribute selected for configuration is the “revenue” attribute, which in this case is a measure of company size. In one embodiment, to make configuration conceptually easy for the business, each attribute can be assigned a certain number of points 508. A business may be required to assign points to attributes in such a way that the total amount of points assigned is equal to a particular value, e.g., 100; alternatively, system 100 can normalize the point values assigned by the business. In addition to assigning a point value 508 for the attribute, in one embodiment each potential value or range of values for the attribute is given a grade 510, for example as a percentage. In FIG. 5, for example, revenue is worth 20 points, and revenue of more than $1 billion is worth 100%; $500 million to $1 billion is worth 80%; and revenue of less than $500 million is worth 40%. A lead from a company that has revenue of $400 million would thus receive 8 points (40% of 20) for its revenue when the lead is scored for this particular business. In an alternative embodiment, the business can indicate qualitatively that a particular attribute is not important, important, very important, and the like, for example by use of a slider bar or other input. Qualitative responses such as these are then normalized to a numeric equivalent, either on an absolute scale, or using a baseline such as an industry standard point value being equated to a business' response of “somewhat important.”

A business can proceed to assign point values for each attribute, and grades for each value or range of values of each attribute as described above. In one embodiment, the total number of points available and the weights given each point are normalized, e.g., to 100. This combination of attributes, point values, and grades forms the quality profile for a business. Note that a business may elect to assign a point value of zero to one or more attributes, meaning that those attributes will not influence a lead's score. In addition, the business can add its own attributes and assign point values to the added attributes as described above.

In one embodiment, default quality profiles are made available to businesses. A default quality profile includes pre-set point values for a plurality of attributes. Multiple default quality profiles may be available, and each may be preconfigured to be of benefit to different types of businesses. For example, the default quality profile designed for a fledgling startup in one market may have different point values assigned to attributes than a default quality profile designed for a large international corporation in a different market. The attributes scored in different default quality profiles may themselves also be different, reflecting the different requirements of different types of businesses of different size.

Individuals within a business can share the same quality profile settings. For example, a group of sales representatives may agree on a target customer profile and all use the same quality profile settings to acquire sales leads. Alternatively, the individuals can establish their own separate profiles to be applied in scoring leads.

A business can also select which leads it would like to be shown. In region 512, a business can choose a minimum point value below which leads will not be presented to the business. In the illustrated embodiment of FIG. 5, separate filters can be set for leads originating at the business' web site 104 (“My Leads”), and for leads provided via another source, such as a network lead described further below.

FIG. 4 provides an example of a quality profile record 402, which includes a unique identifier 404 for the business, bibliographic information 406 about the business (such as contact information, for example), the values associated with the quality profile 408, and the business' lead history 410. The lead history is a record of the leads previously offered to the business, as described below.

Prior to scoring a lead 102, and referring now to FIG. 6, in one embodiment scoring engine 106 receives 602 response data from the lead and determines 604 whether the lead is already known to system 100. If the lead is known to system 100, then a lead record 302 exists in leads database 108. A stored lead record can be compared 606 against the new data received by system 100 in order to validate the new data. Where the data is inconsistent, an alert is preferably generated 610 for subsequent review, e.g., by an analyst. This validation process is particularly useful where the lead record 302 already stored in leads database 108 has a source 308 other than the lead itself. For example, if the data in lead record 302 comes from a third-party financial report, it may be either more or less accurate than the data provided directly by the lead. Even if the data provided by the lead does not conflict with the data already in the lead record 302, the data provided by the lead may contain less information than is already present in the lead record. If so 608, then the lead record is supplemented 612 with known data from the lead record, and then scored 618 by scoring engine 106. Lead records from third parties may also be acquired to support the append process described. If 604 there is no prior lead record 302 for the lead, then scoring engine 106 determines whether the data received from the lead is sufficient to create a scored lead record. If so 614, then the lead is scored 618. If not, the lead is flagged 616 for review or, alternatively, is discarded. After a lead has been scored 618, the new or updated lead record 302 is stored 620 in leads database 108.

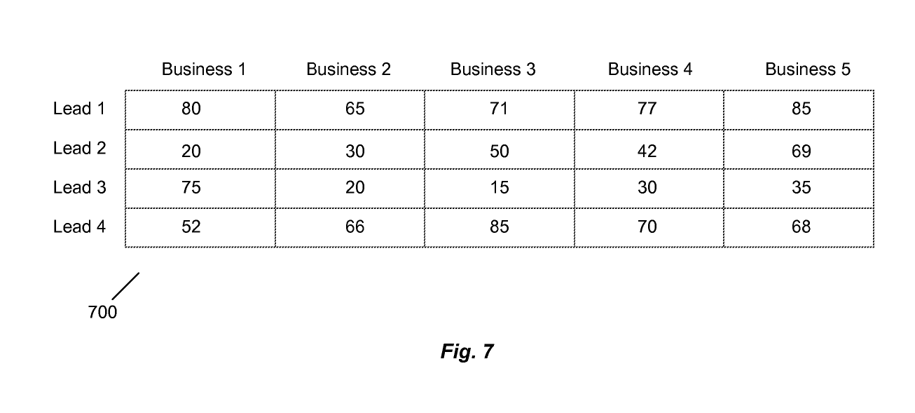

Once a lead is ready to be scored, scoring engine 106 evaluates the lead against the quality profile of the business and determines a score for the combination of the lead and the business. In one embodiment, the score is stored in a data table such as data table 700 of FIG. 7. Scoring engine 106 preferably scores a lead not just for the business 112 associated with the source of the lead, but also for other businesses 114, 116, etc., known to system 100. In one embodiment, the lead is scored for every business known to system 100; in other embodiments, it is only scored for a subset of businesses, such as those businesses in the same industry as the source of the lead. Other criteria, e.g., geography, may also be used to limit the number of businesses for whom the lead is scored. Note that scoring in one embodiment is done in real time, while in another embodiment new leads are queued and scored in a batch process, for example overnight or during other times of low system usage in order to reduce processor load.

Once a lead has been scored, its lead record 302 is stored in leads database 108. Leads engine 110 retrieves new or updated leads records 302 from leads database 108 and processes them according to their score. As described above, each business has associated with it a minimum quality profile score. If a lead receives a score for that business of less than the minimum score, leads engine 110 will not present the lead to the business. The minimum quality profile score may be explicitly set by the business through a user interface element 512, it may be associated with a template quality profile, or alternatively may be set by the operator of system 100.

Leads engine 110 first determines from table 700 the lead's score for the business listed as the source 308 in the lead record 304. If the score exceeds the minimum score for that business, then the lead is queued for presentation to the business as described below. If the score does not exceed the minimum score for that business, then the lead may be evaluated for presentation to other businesses, also as described below.

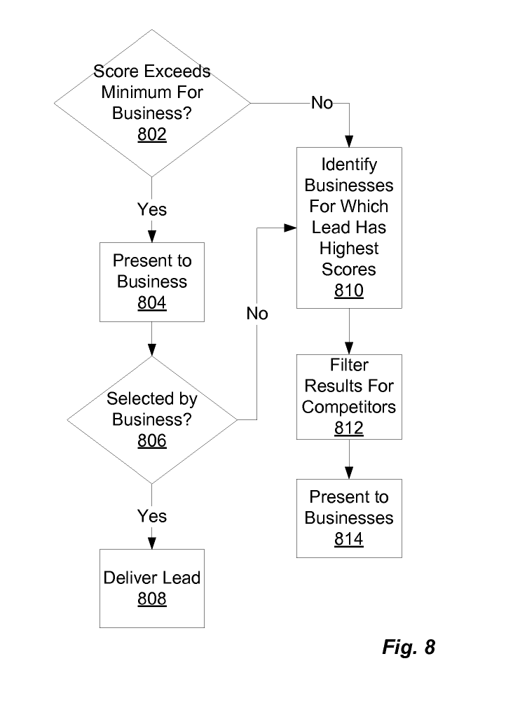

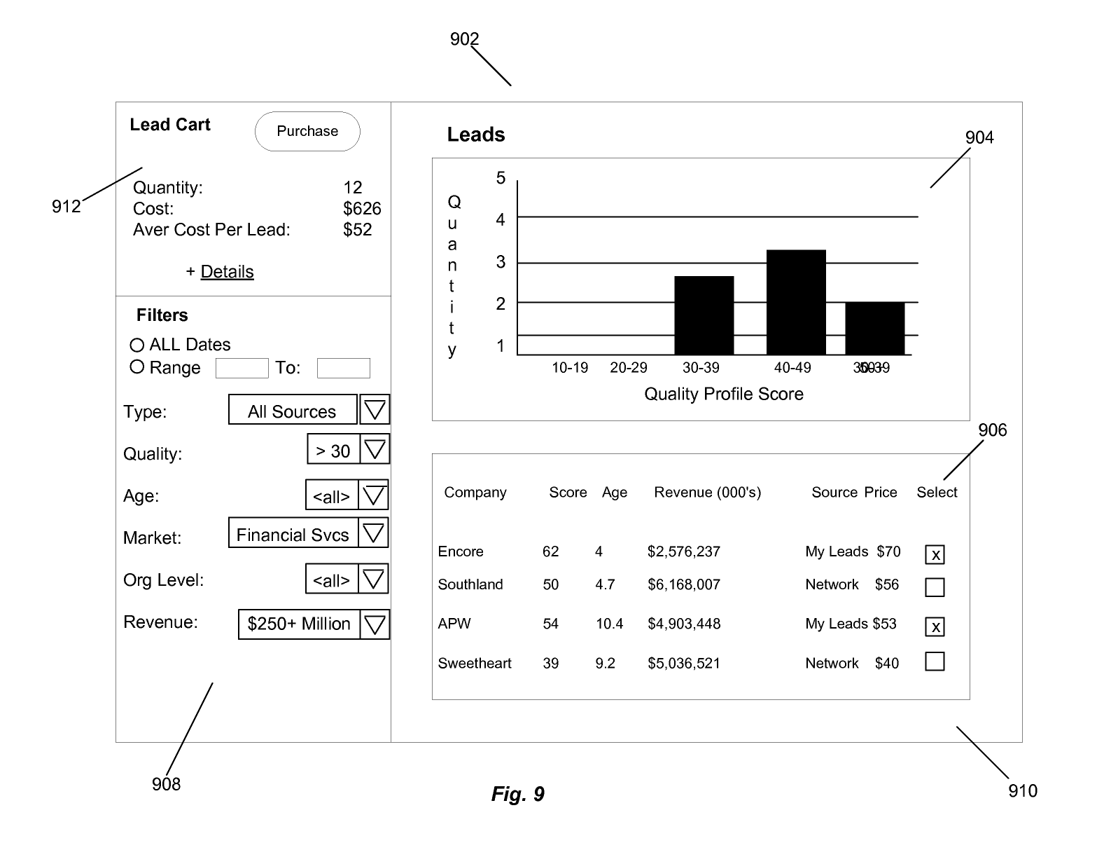

FIG. 8 is a flowchart that illustrates a manner in which leads engine 110 delivers leads to businesses. First, leads engine 110 determines 802 whether the lead's score for source 308 of the lead exceeds the minimum quality profile score for the source business. If so, then leads engine 110 presents 804 the lead to the business. An example user interface for providing a lead to a business is illustrated in FIG. 9 and described below. If the business selects 806 the lead, then the lead is delivered 808 to the business and becomes part of the sales pipelines for that business. If the lead is not selected 806 by the business and the business elects to exchange the lead in return for credit as described below, then leads engine 110 identifies 810 the businesses for which the lead has the highest score. For example, leads engine 110 in one embodiment determines the top five scores the lead has received and the business associated with each of those scores. In various embodiments the number of scores selected may be higher or lower. In one embodiment, once a lead is presented to a business, the lead history 410 in that business' quality profile 402 is updated to reflect that the business has been presented with the lead. This allows leads engine 110 to avoid offering the same lead to the same business more than once, and allows businesses to perform additional filtering on leads, e.g., to view only new leads. In one embodiment, a business that agrees to share its unwanted leads with other businesses is given a financial reward, such as a credit to its account or a discount on the purchase of future leads. Also, in one embodiment leads are automatically offered to other businesses if their scores either do not meet the minimum threshold for a first business, or if they are rejected by the first business. In an alternative embodiment, the business elects to either share or not share the lead with other businesses. This election can be made per lead, per industry, for a range of scores, or according to other criteria that a business may select.

In one embodiment, a business identifies other businesses with which its rejected leads are not to be shared. This allows a business to refuse a lead without worrying that the lead will then be presented to the business' primary competitor. Leads engine 110 accordingly filters 812 the top scores to remove any businesses on the block list of the source 308, and replaces any disqualified businesses with the businesses for which the lead has the next highest scores. In one embodiment, matching businesses are then presented to the lead in an email communication from the host recommending alternate sources as, for example, “better fits”. If the lead clicks on one or more of the matched businesses, the businesses are then presented 814 with the lead, and their lead history fields 410 are updated. In another embodiment, the businesses are presented 814 with the lead automatically without requiring the prospective customer to first indicate an interest.

FIG. 9 illustrates an example of a user interface 902 for providing leads to a business. One region 910 of the UI 902 provides a listing of the leads presented to the business by lead engine 110. In the illustrated example, listing 910 includes both leads being presented initially to the business as well as network leads, i.e. leads that have been previously rejected by another business and are now being offered as described in step 814. In addition to identifying the source of the lead as either original or network, listing 910 indicates how old the lead is, the cost of purchasing the lead, and provides information about the lead such as its name, score, industry, size, revenue, completeness of information, and other attributes 310. A business can preferably modify listing 910 to include or exclude fields according to preference. Each entry also includes a selection box 906 that can be checked to indicate that the business would like to have the lead delivered.

A second region 904 provides a graphical indication of the number of leads presented for a range of scores. A filter region 908 allows a business to control how many leads are displayed by adding or removing filters associated with attributes.

Additional filters and screening tools allow businesses to sort, omit, or group leads. Each lead may be acquired singularly or in groups using an online shopping cart purchase system. Another region 912 provides a summary of the quantity of leads selected, the total cost and average cost-per-lead, and a link to additional details, for example including each of the leads selected for purchase, and the individual lead scores and prices. By pressing a “Purchase” button, the leads are delivered to the business, the lead history field 410 is updated to reflect the purchase, and the business is charged. Purchased leads may be exported to external files or other systems automatically at the discretion of the business.

In one embodiment, a price charged to a business for a lead is based on the lead's score for the business—that is, the higher the lead scores for the business, the higher the price of having that lead delivered. Price can also be adjusted according to factors including the age of the lead, the number of previous rejections for the lead, the source of the lead, the industry the lead is in, and the level of completeness of information available about the lead. Thus, a lead might be offered to a first business at a first price, and to a second business at a second price, the prices determined according to both the value of the lead to the business—i.e. the lead's score for the business, and according to qualities of the business itself, e.g., its size, historical volume of leads purchased, or other factors.

In one embodiment, businesses 112, 114, 116, etc., have CRM software operating in communication with system 100. The CRM software provides system 100 with information about whether leads purchased from system 100 turn in to actual selling opportunities, or sales pipeline. Leads engine 110 correlates the sales information for a lead with the score the lead received for that business, and updates the lead history 410 for that business to reflect the sales information. By analyzing the relationship between scores and the historical sales metrics for a business, lead engine 110 can then predict for a given business and a given lead score the expected revenue, sales cycle, and sales close rate for each lead. This analysis can be carried out using conventional statistical analysis methods, as will be apparent to those of skill in the art. A business can in one embodiment apply a filter 908 to view only leads expected to generate revenue of greater than a threshold amount for the business, if purchased.

As will be appreciated by those of skill in the art, a lead 102 can be provided to system 100 for scoring and delivery to businesses through other methods in addition to via web site 104. For example, a sales representative from a business 112 may attend a trade show and collect a number of business cards from potential leads. Those leads can then be provided to system 100 and scored as described above. Similarly, leads can be imported to system 100 from a conventional customer relationship management (CRM) application or from other sources and be scored and distributed by system 100.

As will also be appreciated by those of skill in the art, while in the above description sales leads are provided to businesses, the present invention has broader application and is not intended to be limited to the described embodiments. For example, lead score can be used to monitor program performance of marketing vendors alerting businesses of certain trends or thresholds. Further, the quantitative value of the score in combination with actual selling results can be used to optimize marketing budgets and program mix to meet a revenue plan. Leads

In one embodiment, leads 102 are potential customers interested in obtaining services such as mortgages or loans from businesses 112. In such an embodiment the quality profiles applied on behalf of each business are used to determine a score indicative of the relative degree of risk each potential customer 102 represents to the business based on the weights given to each attribute by the business. For example, a first business may have a strong preference for providing new car loans to married customers over 30 years old; another may prefer customers who have college educations. The businesses accordingly adjust their quality profiles to favor customers having attributes they prefer.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the feature of the present invention in terms of algorithms and symbolic representations of operations on information. These algorithmic descriptions and representations are the means used by those skilled in the data searching arts to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality. It should be borne in mind, however, that all of these and similar terms are to be associated with the appropriate physical quantities and are merely convenient labels applied to these quantities.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

I claim:

1. A computer-implemented method for providing sales leads to a business, the method comprising:
receiving information about a prospective customer, the information including values for a plurality of attributes;
for each of a plurality of businesses:
applying scoring criteria of the business to the attribute values to determine a score for the prospective customer with respect to the business; and
responsive to the score exceeding a threshold amount, providing the received information to the business.

2. The computer-implemented method of claim 1 wherein the threshold amount is determined by each business.

3. The computer-implemented method of claim 1 wherein the information about the prospective customer is received from the prospective customer.

4. The computer-implemented method of claim 1 wherein the information about the prospective customer is received from a third-party.

5. The computer-implemented method of claim 1 wherein a first portion of the information about the prospective customer is received from the prospective customer and a second portion of the information is received from a third party.

6. The method of claim 1 further comprising receiving a request from the business for contact information for the prospective customer.

7. The method of claim 6 further comprising receiving payment from the business in exchange for providing the contact information to the business.

8. The method of claim 1 further comprising:
responsive to the score not exceeding the threshold amount, providing a rejection message to the prospective customer.

9. The method of claim 8 wherein the rejection message includes recommending another of the plurality of businesses to the potential customer.

10. The method of claim 1 wherein the attributes include the prospective customer's revenue.

11. The method of claim 1 wherein the attributes include the prospective customer's size.

12. The method of claim 11 wherein the prospective customer's size includes the prospective customer's number of employees.

13. The method of claim 1 wherein the attributes include the prospective customer's industry.

14. The method of claim 1 wherein the attributes include the prospective customer's location.

15. The method of claim 1 wherein the attributes include the prospective customer's operating title

16. The method of claim 1 wherein the scoring criteria of the business includes a point value applicable to each of a range of values for each attribute, and applying the scoring criteria of the business further comprises:
for each attribute value, determining the point value applicable to the attribute value; and
determining the score based on the applicable point values for the attribute values.

17. The method of claim 16 further comprising:
applying a weighting to each point value; and
determining the score for the prospective customer based on the weighted point values.

18. The method of claim 16 wherein the point value is determined according to qualitative inputs provided by the business.

19. The method of claim 1 wherein the information about the prospective customer is received by a web server.

20. The method of claim 1 wherein the information about the prospective client is received from the prospective client.

21. The method of claim 1 wherein the information about the prospective client is received from a third party.

22. A system for providing sales leads to a business, the system comprising:
a quality profiles database for storing scoring criteria for a plurality of businesses;
a scoring engine, adapted to:
receive information about a prospective customer of one of the businesses, the information including values for a plurality of attributes;
retrieve the criteria for the business; and
apply the scoring criteria of the business to the attribute values to determine a score for the prospective customer

23. The system of claim 22 further comprising a leads database for storing the prospective customer information and the determined score.

24. The system of claim 22 further comprising a leads engine, for providing the prospective customer information and the determined score to the business.

25. The system of claim 24 wherein the leads engine is adapted to provide the prospective customer information and the determined score to the business responsive to the score exceeding a threshold associated with the business.

26. A computer program product for providing sales leads to a business, the computer program product stored on a computer-readable medium and including code configured to cause a processor to carry out the steps of:
receiving information about a prospective customer, the information including values for a plurality of attributes;
for each of a plurality of businesses:
applying scoring criteria of the business to the attribute values to determine a score for the prospective customer with respect to the business; and
responsive to the score exceeding a threshold amount, providing the received information to the business.

27. The computer program product of claim 26, wherein the threshold amount is determined by each business.

28. The computer program product of claim 26, wherein the information about the prospective customer is received from the prospective customer.

29. The computer program product of claim 26, wherein the information about the prospective customer is received from a third-party.

30. The computer program product of claim 26, wherein a first portion of the information about the prospective customer is received from the prospective customer and a second portion of the information is received from a third party.

31. The computer program product of claim 26, further comprising receiving a request from the business for contact information for the prospective customer.

32. The computer program product of claim 26, further comprising:
responsive to the score not exceeding the threshold amount, providing a rejection message to the prospective customer.

33. The computer program product of claim 32, wherein the rejection message includes recommending another of the plurality of businesses to the potential customer.

34. The computer program product of claim 26, wherein the attributes include the prospective customer's revenue.

35. The computer program product of claim 26, wherein the attributes include the prospective customer's size.

36. The computer program product of claim 26, wherein the attributes include the prospective customer's industry.

37. The computer program product of claim 26, wherein the attributes include the prospective customer's location.

38. The computer program product of claim 26, wherein the attributes include the prospective customer's operating title

39. The computer program product of claim 26, wherein the scoring criteria of the business includes a point value applicable to each of a range of values for each attribute, and applying the scoring criteria of the business further comprises:
for each attribute value, determining the point value applicable to the attribute value; and
determining the score based on the applicable point values for the attribute values.

40. The computer program product of claim 39, further comprising:
applying a weighting to each point value; and
determining the score for the prospective customer based on the weighted point values.

41. The computer program product of claim 39 wherein the point value is determined according to qualitative inputs provided by the business.

42. The computer program product of claim 26, wherein the information about the prospective client is received from the prospective client.

43. The computer program product of claim 26, wherein the information about the prospective client is received from a third party.
